(19) United States
(12) Patent Application Publication
(10) Pub. No.: US 2025/0247923 A1
(43) Pub. Date: Jul. 31, 2025

(54) HEATING COOKER

(71) Applicant: SHARP KABUSHIKI KAISHA, Sakai City (JP)

(72) Inventor: Miu IIDA, Sakai City (JP)

(21) Appl. No.: 18/982,007

(22) Filed: Dec. 16, 2024

(30) Foreign Application Priority Data
Jan. 31, 2024 (JP) 2024-012939

(51) Int. Cl. H05B 6/64

(52) U.S. Cl. CPC H05B 6/6438; H05B 6/6444; H05B 6/6473

(57) ABSTRACT

A heating cooker includes: a first heating cooking chamber in which a cooking target is accommodated; a heating unit configured to heat the cooking target; a display unit configured to display a screen related to cooking of the cooking target; an operation unit configured to receive an operation of a user; and a control unit configured to control the heating unit and the display unit, wherein the display unit displays a switch image indicating switching as to whether or not some functions of heating processing by the heating unit are restricted, when an operation of switching to restrict the some functions is received by the operation unit, the control unit controls the heating unit such that the some functions are restricted, and the some functions correspond to actions restricted on Jewish Sabbath.

### BACKGROUND OF THE INVENTION

### 1. Technical Field

The present disclosure relates to a heating cooker.

### 2. Description of the Related Art

US 2014/0196711 A discloses a control system for automatically operating a cooking appliance during a holiday period under Orthodox Jewish law. The control system in US 2014/0196711 A can provide a plurality of cycles of activation and subsequent deactivation of a heater element according to a predetermined schedule for a predetermined period that is longer than the holiday period using a timer.

### SUMMARY

In general, there is a certain amount of secular Jews who do not strictly follow Orthodox Jewish law. The control system in US 2014/0196711 A cannot be operated during the holiday period, and is not convenient for a secular Jew.

The present disclosure has been made in view of the above problems, and an object of the present disclosure is to provide a heating cooker capable of improving convenience for a secular Jew.

A heating cooker according to an aspect of the present disclosure includes a first heating cooking chamber, a heating unit, a display unit, an operation unit, and a control unit. A cooking target is accommodated in the first heating cooking chamber. The heating unit heats the cooking target. The display unit displays a screen related to cooking of the cooking target. The operation unit receives a user's operation. The control unit controls the heating unit and the display unit. The display unit displays a switch image indicating switching as to whether or not some functions of heating processing by the heating unit are restricted. When an operation of switching to restrict the some functions is received by the operation unit, the control unit controls the heating unit such that the some functions are restricted. The some functions correspond to actions restricted on Jewish Sabbath.

According to the present disclosure, it is possible to improve convenience for a secular Jew.

### BRIEF DESCRIPTION OF THE DRAWINGS

FIG. 1 is a diagram illustrating a cooking system according to the present embodiment;

FIG. 2 is a functional block diagram of the cooking system according to the present embodiment;

FIG. 3 is a diagram illustrating a main menu screen displayed on a display unit of the cooking system;

FIG. 4 is a diagram illustrating an example of a switch screen displayed on the display unit of the cooking system;

FIG. 5 is a diagram illustrating another example of the switch screen displayed on the display unit of the cooking system;

FIG. 6 is a diagram illustrating a temperature setting screen displayed on the display unit of the cooking system;

FIG. 7 is a diagram illustrating a heating period setting screen displayed on the display unit of the cooking system;

FIG. 8 is a diagram illustrating a preheating screen displayed on the display unit of the cooking system;

FIG. 9 is a diagram illustrating a heating screen displayed on the display unit of the cooking system;

FIG. 10 is a diagram illustrating a cooking system in a state where a drawer is in a drawn-out state; and

FIG. 11 is a flowchart illustrating a mode switching method in the cooking system according to the present embodiment.

### DETAILED DESCRIPTION

Hereinafter, embodiments of the present disclosure will be described with reference to the drawings. Note that, in the drawings, the same or corresponding portions are denoted by the same reference numerals, and descriptions thereof will not be repeated.

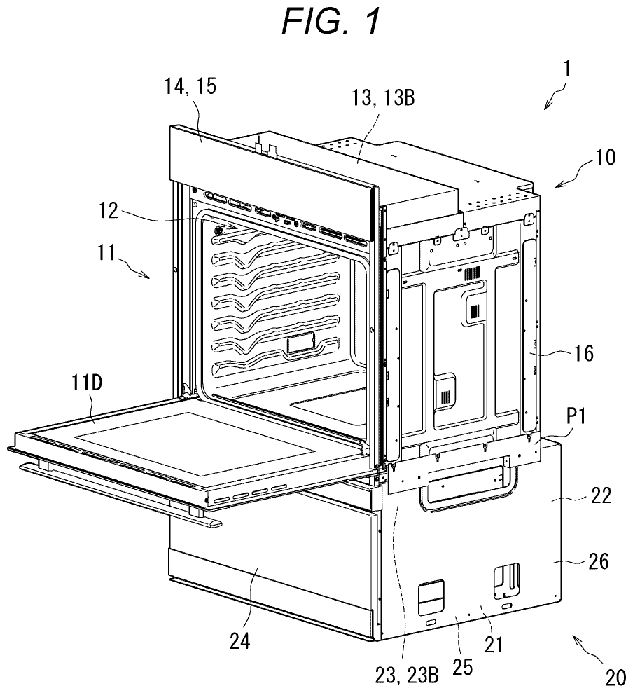

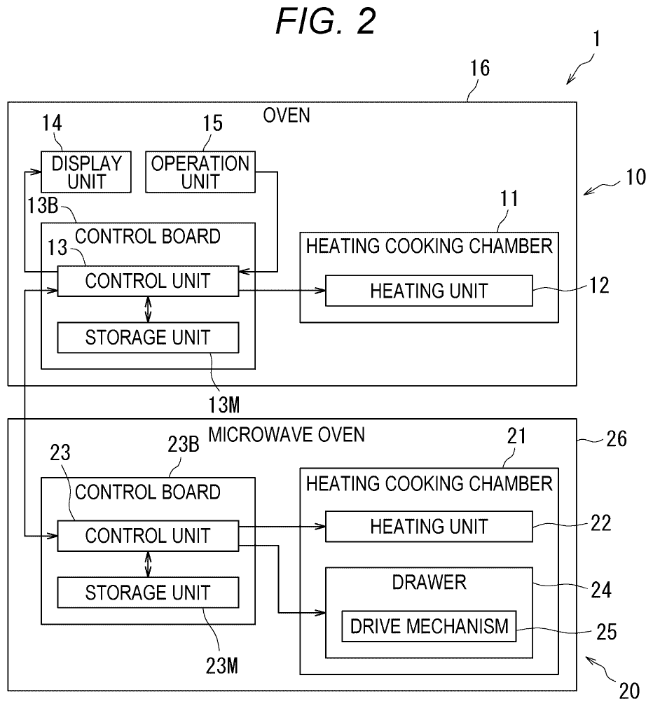

A cooking system 1 according to the present embodiment will be described with reference to FIGS. 1 and 2. FIG. 1 is a diagram illustrating the cooking system 1 according to the present embodiment. FIG. 2 is a functional block diagram of the cooking system 1 according to the present embodiment.

The cooking system 1 includes an oven 10 and a microwave oven 20. The microwave oven 20 is an example of a microwave oven. In the present embodiment, a side of the oven 10 on which an opening and closing door 11D to be described later is disposed is defined as a front side of the oven 10 (cooking system 1), and a side (back surface side) opposite to the front side is defined as a rear side of the oven 10 (cooking system 1). In addition, a right side when the oven 10 (cooking system 1) is viewed from the front side is defined as a right side of the oven 10 (cooking system 1), and a side opposite to the right side is defined as a left side of the oven 10 (cooking system 1). In addition, in a direction orthogonal to a front-rear direction and a left-right direction of the oven 10 (cooking system 1), a side on which a display unit 14 and an operation unit 15 to be described later are arranged is defined as an upper side of the oven 10 (cooking system 1), and a side (bottom side) opposite to the upper side is defined as a lower side of the oven 10 (cooking system 1). Note that these orientations do not limit the orientation of the oven 10 (cooking system 1) of the present disclosure during use.

In the present embodiment, the oven 10 and the microwave oven 20 are arranged next to each other in an up-down direction. Specifically, the oven 10 is disposed above the microwave oven 20. The oven 10 and the microwave oven 20 are examples of the heating cooker.

### Oven 10

The oven 10 includes a heating cooking chamber 11, the opening and closing door 11D, a heating unit 12, a control unit 13, the display unit 14, the operation unit 15, and a housing 16.

As illustrated in FIG. 1, the housing 16 has, for example, a substantially rectangular parallelepiped shape with a front surface opened. The heating cooking chamber 11 is provided inside the housing 16. A cooking target (not illustrated) is accommodated in the heating cooking chamber 11. The heating cooking chamber 11 is an example of a first heating cooking chamber. Typically, the housing 16 is formed of a metal chassis. For example, the heating cooking chamber 11 and the housing 16 are integrally formed. The heating cooking chamber 11 is formed inside the housing 16, and is covered with a heat-resistant insulator.

The opening and closing door 11D is a vertically open opening and closing door. Specifically, the opening and closing door 11D is attached to the housing 16 so as to be rotatable about a horizontal axis with a side of a lower portion on the front side of the housing 16 as the horizontal axis. However, the opening and closing door 11D of the present embodiment is not limited to a vertically open door. For example, a horizontally open opening and closing door that is attached to be rotatable about a vertical axis may be used with a side of a side portion on the left side of the housing 16 as the vertical axis.

The heating unit 12 heats a cooking target placed in the heating cooking chamber 11. As an example, the heating unit 12 includes a grill heater (not illustrated) and a blower fan (not illustrated). Typically, the grill heaters are located on the upper side and the lower side of the heating cooking chamber 11. Specifically, the grill heater is attached to each of the ceiling of the heating cooking chamber 11 and the bottom surface (floor surface) of the heating cooking chamber 11. The blower fan is disposed on a wall surface on the rear side of the heating cooking chamber 11. The grill heater and the blower fan perform convection cooking on the cooking target. The grill heater performs bake cooking or grill cooking on the cooking target. Bake cooking is a cooking method of indirectly heating and cooking the cooking target by heating the air in the heating cooking chamber 11. Grill cooking is a cooking method of directly heating and cooking the cooking target using the heat of the grill heater.

The display unit 14 is disposed on the front surface of the housing 16 and above the opening and closing door 11D. The display unit 14 is a liquid crystal display, an organic EL display, or the like having a function of displaying a screen related to cooking of the cooking target. The operation unit 15 receives a user's operation. Typically, the display unit 14 and the operation unit 15 are integrally formed as a touch panel display. For example, the operation unit 15 is a touch sensor provided on the touch panel display. The touch sensor is, for example, a capacitive touch sensor. The touch sensor receives a touch operation, a slide operation, or the like by the user. When detecting the touch operation or the slide operation, the touch sensor outputs a signal indicating a detection result to the control unit 13. Note that the operation unit 15 may be a physical button, a pressure-sensitive touch panel switch, or the like provided separately from the display unit 14, in addition to the touch sensor provided on the touch panel display.

The control unit 13 controls the heating unit 12, the display unit 14, and the operation unit 15. Specifically, the control unit 13 includes a processor such as a central processing unit (CPU) or a micro controller unit (MCU). The control unit 13 is mounted and disposed on a control board 13B. The control board 13B is a multilayer board in which a plurality of conductive layers and a plurality of insulating layers are alternately stacked.

In addition to the control unit 13, a power supply circuit or various circuit elements (not illustrated) are arranged on the control board 13B. For example, a storage unit 13M is arranged on the control board 13B. The storage unit 13M stores various programs, various kinds of data, and the like. Specifically, the storage unit 13M includes a semiconductor memory such as a read only memory (ROM) and a random access memory (RAM), a solid state drive (SSD), or a hard disk drive (HDD). The control unit 13 reads various programs from the storage unit 13M and executes the programs to control the heating unit 12 or control the display on the display unit 14. Note that the storage unit 13M may be provided in the control unit 13 in addition to being provided in the control board 13B separately from the control unit 13. Specifically, the storage unit 13M may be formed as a memory area included in the control unit 13.

### Microwave Oven 20

The microwave oven 20 includes a heating cooking chamber 21, a heating unit 22, a control unit 23, a drawer 24, and a housing 26.

The housing 26 has, for example, a substantially rectangular parallelepiped shape with a front surface opened. The heating cooking chamber 21 is provided inside the housing 26. The heating cooking chamber 21 has a predetermined volume as a space in which the cooking target (not illustrated) can be accommodated. The heating cooking chamber 21 is an example of a second heating cooking chamber. Typically, the housing 26 is formed of a metal chassis.

The drawer 24 can be drawn out along the front-rear direction with respect to the heating cooking chamber 21. The drawer 24 is an example of a drawer unit. In the present embodiment, the drawer 24 includes a drive mechanism 25 such as a motor that drives the drawer 24. The drive mechanism 25 is housed, for example, in a space between a bottom wall of the housing 26 and a bottom wall of the heating cooking chamber 21. The drive mechanism switches between a drawn-out state in which the drawer 24 is drawn out from the heating cooking chamber 21 and a pushed-in state in which the drawer 24 is pushed in the heating cooking chamber 21 under the control of the control unit 23 described later. A door capable of opening and closing an opening on the front side of the heating cooking chamber 21 is provided on the front side of the drawer 24. The door opens the opening on the front side of the heating cooking chamber 21 in the drawn-out state, and closes the opening on the front side of the heating cooking chamber 21 in the pushed-in state.

The heating unit 22 includes a magnetron. The magnetron supplies microwaves to the heating cooking chamber 21 to heat the cooking target placed in the heating cooking chamber 21.

The control unit 23 controls the heating unit 22 and the drawer 24. Specifically, the control unit 13 includes a processor such as a central processing unit (CPU) or a micro controller unit (MCU). The control unit 23 is mounted and disposed on a control board 23B. The control board 23B is a multilayer board in which a plurality of conductive layers and a plurality of insulating layers are alternately stacked.

In addition to the control unit 23, a power supply circuit or various circuit elements (not illustrated) are arranged on the control board 23B. For example, a storage unit 23M is arranged on the control board 23B. The storage unit 23M stores various programs, various kinds of data, and the like. Specifically, the storage unit 13M includes a semiconductor memory such as a read only memory (ROM) and a random access memory (RAM), a solid state drive (SSD), or a hard disk drive (HDD). The control unit 23 reads various programs from the storage unit 23M and executes the programs to control the heating unit 22 or control a drive mechanism for driving the drawer 24. Note that the storage unit 23M may be provided in the control unit 23 in addition to being provided in the control board 23B separately from the control unit 23. Specifically, the storage unit 23M may be formed as a memory area included in the control unit 23.

In the cooking system 1, the control unit 13 of the oven 10 and the control unit 23 of the microwave oven 20 can communicate with each other. For example, the control unit 13 and the control unit 23 are electrically and mechanically connected to each other via a communication harness. As a result, the control unit 13 can control the control unit 23, and can control the heating unit 22 and the drawer 24 via the control unit 23. In addition, the control unit 23 can control the control unit 13, and can control the heating unit 12, the display unit 14, and the operation unit 15 via the control unit 13. That is, the microwave oven 20 performs wired communication with the oven 10. Note that the oven 10 and the microwave oven 20 may communicate with each other by wireless communication in addition to wired communication with each other via a communication harness, for example.

In addition, in the cooking system 1, the housing 16 of the oven 10 and the housing 26 of the microwave oven 20 are mechanically connected to each other by a conductive metal connection member P1. Specifically, the connection member P1 is attached to the lower side on the right side of the housing 16 and the upper side on the right side of the housing 26, and is attached to the lower side on the left side of the housing 16 and the upper side on the left side of the housing 26 (not illustrated in FIG. 1).

The cooking system 1 can be operated in a normal mode in which all functions related to heating processing of the cooking target by the heating unit 12 and the heating unit 22 can be used, or a restricted mode (Sabbath MODE) in which some functions of the heating processing of the cooking target by the heating unit 12 and the heating unit 22 are restricted. In the cooking system 1, the normal mode and the restricted mode (Sabbath MODE) can be switched to each other.

In the restricted mode (Sabbath MODE), among the functions related to the heating processing, the function corresponding to the action restricted on the Jewish Sabbath is restricted. For example, it is prohibited to use fire or electrical appliances since they must not work if they strictly comply with Orthodox Jewish law. It may be allowed to keep cooked dishes warm using a lit stove or a preheated oven, but it is very inconvenient if electrical appliances cannot be used. Therefore, by providing the restricted mode (Sabbath MODE), it is not possible to use all the functions for a secular Jew, but by allowing only some of the functions to be used, convenience is improved on the Jewish Sabbath. Accordingly, the restricted mode (Sabbath MODE) of the present disclosure does not correspond to all actions restricted on the Jewish Sabbath, and does not completely restrict turning on and off of, for example, a heating unit, a lighting device (indoor lamp), a display unit (backlight), and the like.

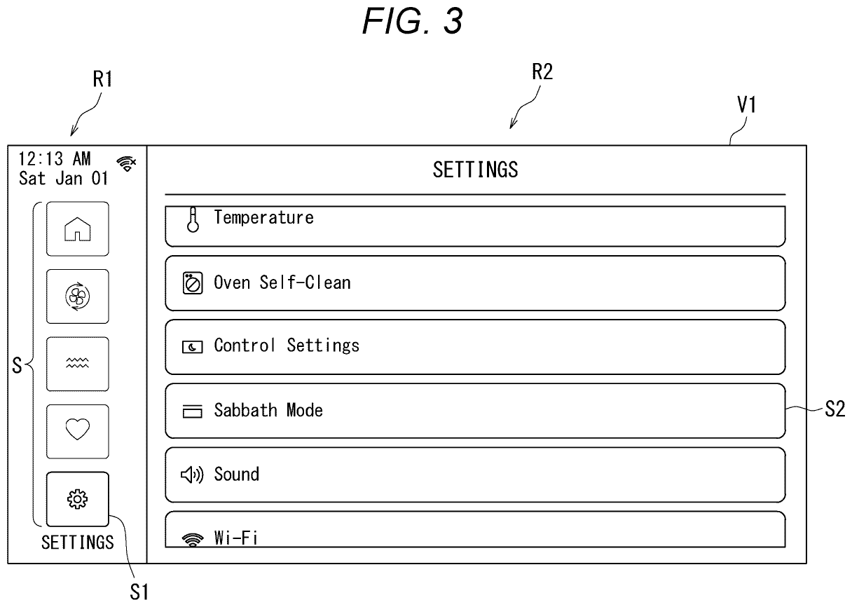

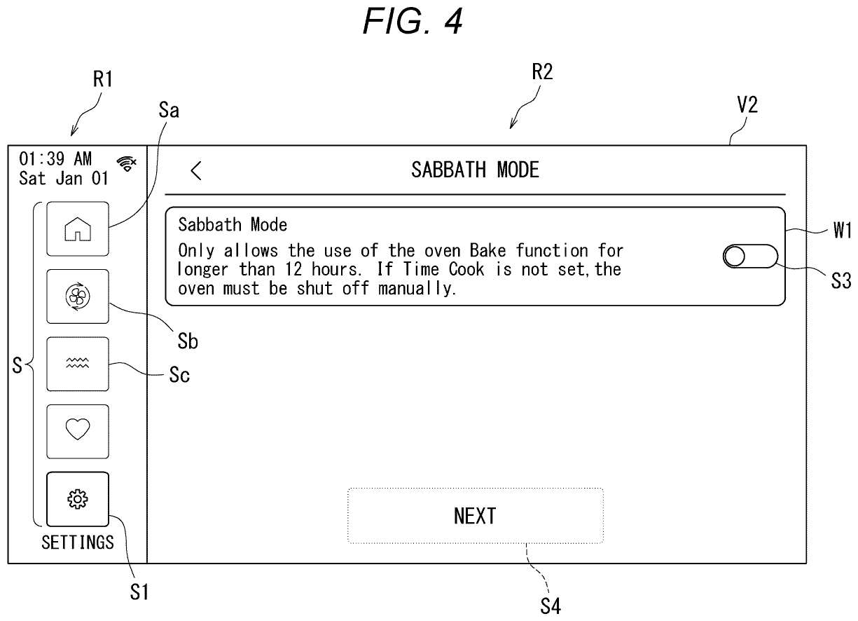

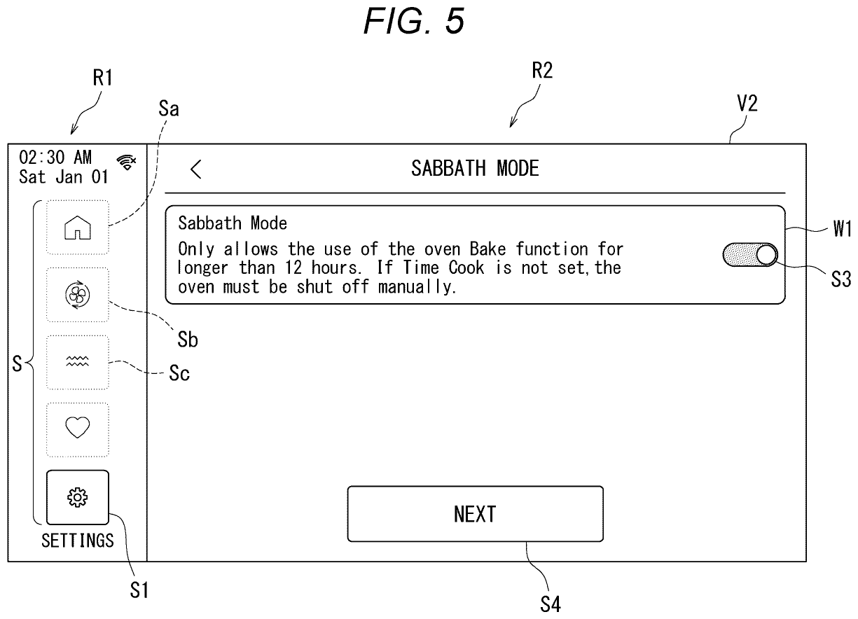

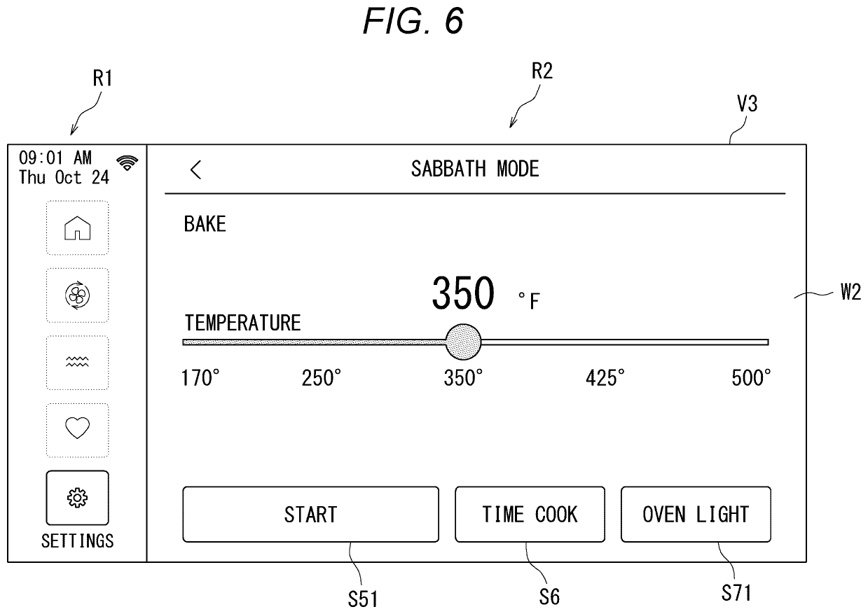

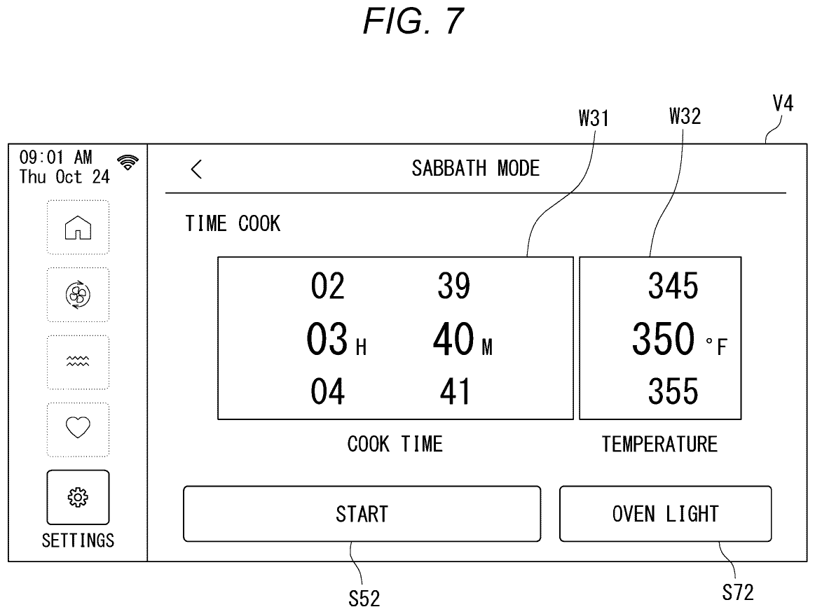

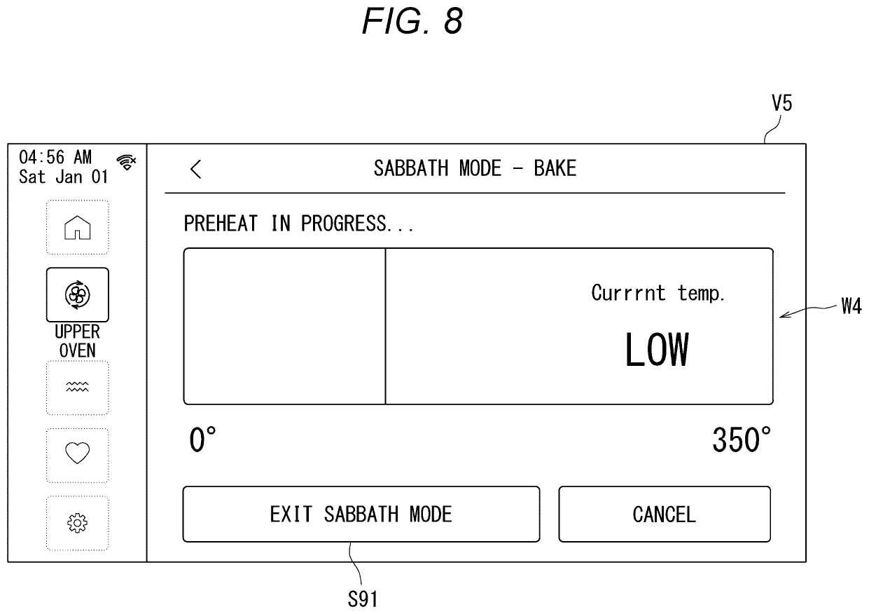

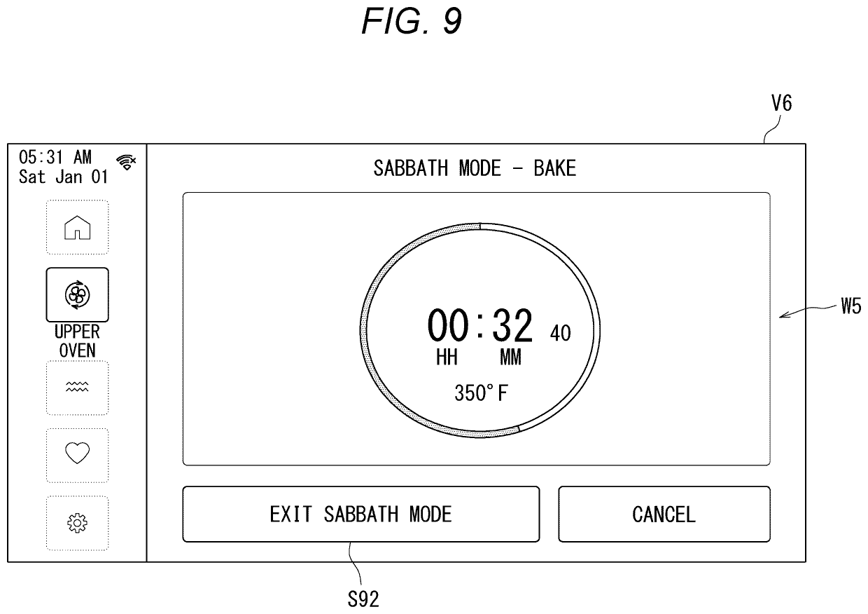

Next, an operation in the restricted mode of the cooking system 1 will be described with reference to FIGS. 3 to 9. FIG. 3 is a diagram illustrating a main menu screen V1 displayed on the display unit 14 of the cooking system 1. FIG. 4 is a diagram illustrating an example of a switch screen V2 displayed on the display unit 14 of the cooking system 1. FIG. 5 is a diagram illustrating another example of the switch screen V2 displayed on the display unit 14 of the cooking system 1. FIG. 6 is a diagram illustrating a temperature setting screen V3 displayed on the display unit 14 of the cooking system 1. FIG. 7 is a diagram illustrating a heating period setting screen V4 displayed on the display unit 14 of the cooking system 1. FIG. 8 is a diagram illustrating a preheating screen V5 displayed on the display unit 14 of the cooking system 1. FIG. 9 is a diagram illustrating a heating screen V6 displayed on the display unit 14 of the cooking system 1.

In the cooking system 1, for example, when an operation is input to the operation unit 15 or the opening and closing door 11D is opened, the control unit 13 controls the display unit 14 to display the main menu screen V1.

The main menu screen V1 illustrated in FIG. 3 includes a first region R1 and a second region R2. In the first region R1, a plurality of icons S corresponding to various functions of the cooking system 1 is arranged side by side. As an example, the plurality of icons S includes an icon S1 corresponding to a setting function for setting various setting items of the cooking system 1.

In the second region R2, contents corresponding to the icon S selected by the user among the plurality of icons S arranged in the first region R1 are displayed. Hereinafter, in the present embodiment, a state where the user performs a touch operation or a slide operation on the icon S displayed on the display unit 14 will be referred to as “selected”.

As illustrated in FIG. 3, when the icon S1 is selected, icons corresponding to a plurality of setting items is arranged next to each other in the second region R2. The plurality of icons arranged in the second region R2 includes an icon S2 indicating the restricted mode (Sabbath MODE).

When the icon S2 is selected by the user, the control unit 13 controls the display unit 14 to display the switch screen V2. The switch screen V2 is a screen for guiding switching between the normal mode and the restricted mode. The display content in the second region R2 of the switch screen V2 is different from that of the main menu screen V1. That is, the control unit 13 changes the display content in the second region R2 of the main menu screen V1 and displays the switch screen V2 on the display unit 14.

The second region R2 of the switch screen V2 includes a message window W1 including an explanatory sentence for the restricted mode (Sabbath MODE). The message window W1 includes a switch icon S3 indicating switching of a selected state (ON) or a non-selected state (OFF) of the restricted mode (Sabbath MODE). Regarding the switch icon S3, a first display (FIG. 4) and a second display (FIG. 5) are switched depending on whether or not the restricted mode (Sabbath MODE) is in the selected state (ON) or the non-selected state (OFF).

FIG. 4 illustrates the switch screen V2 when the restricted mode (Sabbath MODE) is in the non-selected state (OFF). At this time, the control unit 13 controls the cooking system 1 in the normal mode. That is, the switch icon S3 in the first display indicates that the cooking system 1 is in the normal mode.

In the present embodiment, the switch icon S3 is a toggle switch. The first display of the switch icon S3 indicates, for example, a state in which the switch is positioned at a left end of a slide bar and the slide bar is displayed in the same color as the background color of the second region R2. The switch icon S3 is an example of a switch image.

Furthermore, an icon S4 is arranged in the second region R2 of the switch screen V2. For example, the icon S4 is positioned below the message window W1 in the second region R2. The icon S4 is an icon indicating transition to the temperature setting screen V3 or the heating period setting screen V4. The temperature setting screen V3 and the heating period setting screen V4 are screens displayed on the display unit 14 in the restricted mode (Sabbath MODE), and are examples of screens when the heating processing is performed by the heating unit 12 with some functions restricted.

In the normal mode (FIG. 4), the icon S4 is controlled such that a touch operation or a slide operation on the icon S4 is invalidated. At this time, for example, the control unit 13 controls the display unit 14 to display the icon S4 in a grayed-out manner. In FIG. 4, the icon S4 displayed in a grayed-out manner is indicated by a broken line.

In this state, when the switch icon S3 is selected by the user, in other words, when an operation of switching to restrict some functions is received by the operation unit 15, the control unit 13 switches the cooking system 1 from the normal mode to the restricted mode (Sabbath MODE), and controls the display unit 14 such that the switch icon S3 on the switch screen V2 is switched to be displayed in the second display (FIG. 5). The second display of the switch icon S3 indicates, for example, a state in which the switch is positioned at a right end of the slide bar and the slide bar is displayed in the different color from the background color of the second region R2. In FIG. 5, hatching indicates that the color of the slide bar is different from the background color of the second region R2.

In this manner, in the cooking system 1, it is possible to present to the user that switching between the normal mode and the restricted mode (Sabbath MODE) is possible on the basis of the user's operation by using the display of the switch icon S3. Thus, the user can arbitrarily switch between the normal mode and the restricted mode (Sabbath MODE). Accordingly, the convenience of the cooking system 1 is improved for a secular Jew. In addition, in a case where the normal mode and the restricted mode (Sabbath MODE) can be switched by the timer control, even when the clock or the timer is inaccurate, the normal mode and the restricted mode (Sabbath MODE) can be switched by the user's operation to reduce the influence of the inaccuracy of the clock or the timer.

In addition, at this time, the control unit 13 performs control such that the icon S4 is validated. Specifically, the control unit 13 controls the display unit 14 to cancel the display of the icon S4 in a grayed-out manner and perform normal display (FIG. 5). Note that the control unit 13 may control the display unit 14 such that the icon S4 is not displayed in the second region R2 in the normal mode and the icon S4 is displayed in the second region R2 in the restricted mode (Sabbath MODE). In the present embodiment, the icon S4 is an example of a transition image. As a result, it is possible to impress the user that the mode has shifted to the restricted mode (Sabbath MODE).

Note that, in FIGS. 4 and 5, the switch icon S3 is drawn as a toggle switch, but the type of the switch icon S3 is not particularly limited.

In addition, when the cooking system 1 is switched from the normal mode to the restricted mode (Sabbath MODE), the control unit 13 controls the display unit 14 such that, among the plurality of icons S arranged in the first region R1, the icons S corresponding to the restricted functions are displayed in a grayed-out manner or are not displayed. For example, the control unit 13 controls display unit 14 such that an icon Sa for displaying a home screen, an icon Sb corresponding to grill cooking, an icon Sc corresponding to microwave cooking, and the like are displayed in a grayed-out manner or not displayed. In the following drawings, the icon S displayed in a grayed-out manner is indicated by a broken line. At this time, the operation unit 15 rejects a touch operation or a slide operation on the icon S displayed in a grayed-out manner. In other words, the operation unit 15 receives only operations related to the functions other than some restricted functions in the restricted mode (Sabbath MODE). As an example, some functions restricted in the restricted mode (Sabbath MODE) include lighting of the backlight of the display unit 14, control of the blower fan, supply of microwaves, and the like.

In this manner, with the cooking system 1, in the restricted mode (Sabbath MODE), the function corresponding to the actions restricted on the Jewish Sabbath is not erroneously activated.

In particular, there is no need to select microwave cooking that is less relevant to maintaining the lit fire.

When the icon S4 in a normal display is selected, the control unit 13 controls the display unit 14 to display the temperature setting screen V3. However, the heating period setting screen V4 may be displayed when the icon S4 is selected. In addition, when the icon S4 is selected, the user may set in advance which of the temperature setting screen V3 and the heating period setting screen V4 is displayed. Hereinafter, switching from the switch screen V2 to the temperature setting screen V3 will be representatively described. Typically, the temperature setting screen V3 and the heating period setting screen V4 are dedicated screens for the restricted mode (Sabbath MODE), but may be shared with the normal mode.

As illustrated in FIG. 6, the display content in the second region R2 of the temperature setting screen V3 is different from that of the switch screen V2. That is, the control unit 13 changes the display content in the second region R2 of the switch screen V2 and displays the temperature setting screen V3 on the display unit 14.

In the second region R2 of the temperature setting screen V3, the contents related to the bake cooking, which is an example of the function usable in the restricted mode (Sabbath MODE), are displayed. Specifically, the second region R2 of the temperature setting screen V3 includes a temperature setting window W2 indicating the setting of the temperature of the heating cooking chamber 11 during the bake cooking. The temperature setting window W2 is an example of a heating temperature setting image indicating the temperature setting of heating by the heating unit 12 (grill heater).

For example, the temperature setting window W2 includes a temperature display indicating a set temperature at the time of the bake cooking and a slide bar for changing the set temperature. When the user selects the slide bar and stops the slide bar at a predetermined position, the temperature corresponding to the stop position is set as the set temperature.

In addition, the second region R2 of the temperature setting screen V3 includes an icon S51 indicating start of bake cooking, an icon S6 indicating transition to the heating period setting screen V4, and an icon S71 for switching on or off of an indoor lamp (not illustrated) arranged in the heating cooking chamber 11, in addition to the temperature setting window W2. For example, the icon S51, the icon S6, and the icon S71 are arranged side by side below the temperature setting window W2. Note that the arrangement of the temperature setting window W2, the icon S51, the icon S6, and the icon S71 in the second region R2 of the temperature setting screen V3 is not limited to the arrangement illustrated in FIG. 5.

For example, when the icon S6 on the temperature setting screen V3 is selected, the control unit 13 controls the display unit 14 to display the heating period setting screen V4 (FIG. 7) instead of the temperature setting screen V3. As illustrated in FIG. 7, the display content in the second region R2 of the heating period setting screen V4 is different from that of the temperature setting screen V3. That is, the control unit 13 changes the display content in the second region R2 of the temperature setting screen V3 and displays the heating period setting screen V4 on the display unit 14.

The second region R2 of the heating period setting screen V4 includes a heating period setting window W31 indicating the period setting of heating by the heating unit 12 (grill heater) at the time of bake cooking, and a temperature setting window W32 corresponding to the temperature setting window W2 of the temperature setting screen V3. The temperature setting window W32 indicates the same contents as the temperature setting window W2 except that the operation of the temperature setting is different from the operation of the temperature setting window W2, and thus the description thereof will be omitted.

In the heating period setting window W31, the heating period is selectively displayed in a drumroll display. For example, the heating period settable in the heating period setting window W31 may exceed 12 hours. The heating period setting window W31 is an example of a heating period setting image indicating the period setting of heating by the heating unit 12.

In addition, the second region R2 of the heating period setting screen V4 includes an icon S52 corresponding to the function (start of bake cooking) of the icon S51 on the temperature setting screen V3, and an icon S72 corresponding to the function (turning on and off of the indoor lamp) of the icon S71 on the temperature setting screen V3, in addition to the heating period setting window W31 and the temperature setting window W32. For example, the icon S52 and the icon S72 are arranged side by side below the heating period setting window W31 and the temperature setting window W32.

Note that each of the temperature setting screen V3 and the heating period setting screen V4 may include an icon (not illustrated) for returning to the screen displayed on the display unit 14 immediately before.

When the icon S51 on the temperature setting screen V3 or the icon S52 on the heating period setting screen V4 is selected, the control unit 13 controls the heating unit 12 (grill heater) on the basis of the set temperature and the heating period set on at least one of the temperature setting screen V3 and the heating period setting screen V4. At this time, the control unit 13 controls the display unit 14 to display the preheating screen V5 (FIG. 8) or the heating screen V6 (FIG. 9). Typically, the preheating screen V5 and the heating screen V6 are dedicated screens for the restricted mode (Sabbath MODE), but may be shared with the normal mode.

For example, in a case where only the set temperature is set on the temperature setting screen V3 and the icon S51 is selected, the control unit 13 controls the display unit 14 to display the preheating screen V5. As illustrated in FIG. 8, the display content in the second region R2 of the preheating screen V5 is different from that of the temperature setting screen V3. That is, the control unit 13 changes the display content in the second region R2 of the temperature setting screen V3 and displays the preheating screen V5 on the display unit 14. The second region R2 of the preheating screen V5 includes a temperature display window W4 indicating the set temperature of the temperature during the bake cooking and the current temperature of the heating cooking chamber 11. In the temperature display window W4, the set temperature and the current temperature of the heating cooking chamber 11 are indicated using a progress bar.

On the other hand, in a case where the set temperature and the heating period are set on the heating period setting screen V4 and the icon S52 is selected, the control unit 13 controls the display unit 14 to display the heating screen V6. As illustrated in FIG. 9, the display content in the second region R2 of the heating screen V6 is different from that of the heating period setting screen V4. That is, the control unit 13 changes the display content in the second region R2 of the heating period setting screen V4 and displays the heating screen V6 on the display unit 14. The second region R2 of the heating screen V6 includes a temperature time display window W5 indicating the set temperature during the bake cooking and the remaining time until the end of the bake cooking. Note that in a case where the set temperature and the heating period are set on the heating period setting screen V4 and the icon S52 is selected, the control unit 13 may control the display unit 14 such that the preheating screen V5 is displayed before the heating screen V6 is displayed.

As described above, the display unit 14 displays at least one of the temperature setting window W2, the heating period setting window W31, and the temperature setting window W32. Accordingly, the user can easily recognize the functions usable in the restricted mode (Sabbath MODE).

In the present embodiment, the preheating screen V5 includes an icon S91 together with the temperature display window W4. The icon S91 indicates guidance of release of the restricted mode (Sabbath MODE). When the icon S91 is selected, the control unit 13 controls the display unit 14 to display the switch screen V2. When the switch icon S3 is selected on the switch screen V2, the control unit 13 ends the restricted mode (Sabbath MODE), and switches to the normal mode. The icon S91 is an example of a restriction release image for guiding the release of the restriction of some functions in the restricted mode (Sabbath MODE).

On the other hand, the heating screen V6 includes an icon S92 together with the temperature time display window W5. Similar to the icon S91, the icon S92 indicates guidance of release of the restricted mode (Sabbath MODE).

By respectively providing the icon S91 and the icon S92, which indicate guidance of release of the restricted mode (Sabbath MODE), on the preheating screen V5 and the heating screen V6, even in the middle of the heating processing by the heating unit 12 in the restricted mode (Sabbath MODE), it is possible to switch to the switch screen V2 and exit from the restricted mode (Sabbath MODE) in the middle.

Note that the icon S91 on the preheating screen V5 and the icon S92 on the heating screen V6 may indicate an instruction to release the restricted mode (Sabbath MODE). In this case, when the icon S91 or the icon S92 is selected, the control unit 13 ends the restricted mode (Sabbath MODE) of the cooking system 1, and switches to the normal mode. For example, when the restricted mode (Sabbath MODE) is released, the control unit 13 controls the display unit 14 to display the main menu screen V1.

In the present embodiment, when a predetermined period has elapsed in a state where the temperature setting screen V3, the heating period setting screen V4, the preheating screen V5, or the heating screen V6 is displayed on the display unit 14, the control unit 13 turns off the backlight of the display unit 14, and controls the display unit 14 to be in a non-display state. Next, when an operation is input to the operation unit 15 or when the opening and closing door 11D is opened, the control unit 13 controls the display unit 14 such that, among the temperature setting screen V3, the heating period setting screen V4, the preheating screen V5, and the heating screen V6, the screen that was displayed on the display unit 14 before the backlight was turned off is displayed.

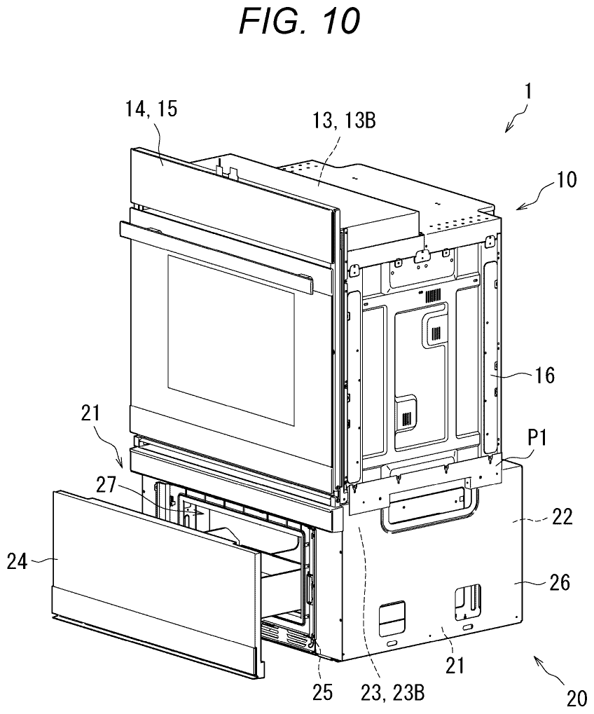

Next, with reference to FIG. 10, an operation at the time of shifting to the restricted mode (Sabbath MODE) will be described. FIG. 10 is a diagram illustrating the cooking system 1 in a state where the drawer 24 is in the drawn-out state.

In a case where the drawer 24 is in the drawn-out state when the cooking system 1 is switched from the normal mode to the restricted mode (Sabbath MODE), the control unit 13 performs control such that the drawer 24 is pushed to the heating cooking chamber 21.

For example, the drawer 24 or the heating cooking chamber 21 is provided with an opening and closing sensor that detects whether or not the drawer 24 is in the pushed-in state or the drawn-out state. When the cooking system 1 is switched from the normal mode to the restricted mode (Sabbath MODE), the control unit 13 determines whether or not the drawer 24 is in the pushed-in state or the drawn-out state on the basis of a detection result of the opening and closing sensor.

When it is determined that the drawer 24 is in the drawn-out state, the control unit 13 switches the switch icon S3 on the switch screen V2 to be in the second display (FIG. 5), and controls the drive mechanism 25 such that the drawer 24 is stored in the heating cooking chamber 21.

In addition, the cooking system 1 also includes an indoor lamp 27 that illuminates the inside of the heating cooking chamber 21. The indoor lamp 27 is an example of a lighting device. The control unit 13 controls the indoor lamp 27 such that the indoor lamp 27 is turned on when the drawer 24 is in the drawn-out state, and controls the indoor lamp 27 such that the indoor lamp 27 is turned off when the drawer 24 is in the pushed-in state. Accordingly, when the cooking system 1 is switched from the normal mode to the restricted mode (Sabbath MODE), in a case where the indoor lamp 27 is turned on, the control unit 13 controls the indoor lamp 27 such that the indoor lamp 27 is turned off.

Specifically, when the cooking system 1 is switched from the normal mode to the restricted mode (Sabbath MODE), in a case where it is determined that the drawer 24 is in the drawn-out state, the control unit 13 controls the drive mechanism 25 such that the drawer 24 is stored in the heating cooking chamber 21, and controls the indoor lamp 27 such that the indoor lamp 27 is turned off.

As described above, when the mode is switched from the normal mode to the restricted mode (Sabbath MODE), by bringing the mode close to the general standby state of the cooking system 1, a situation in which the user operates the cooking system 1 on the Sabbath is less likely to occur in the restricted mode (Sabbath MODE).

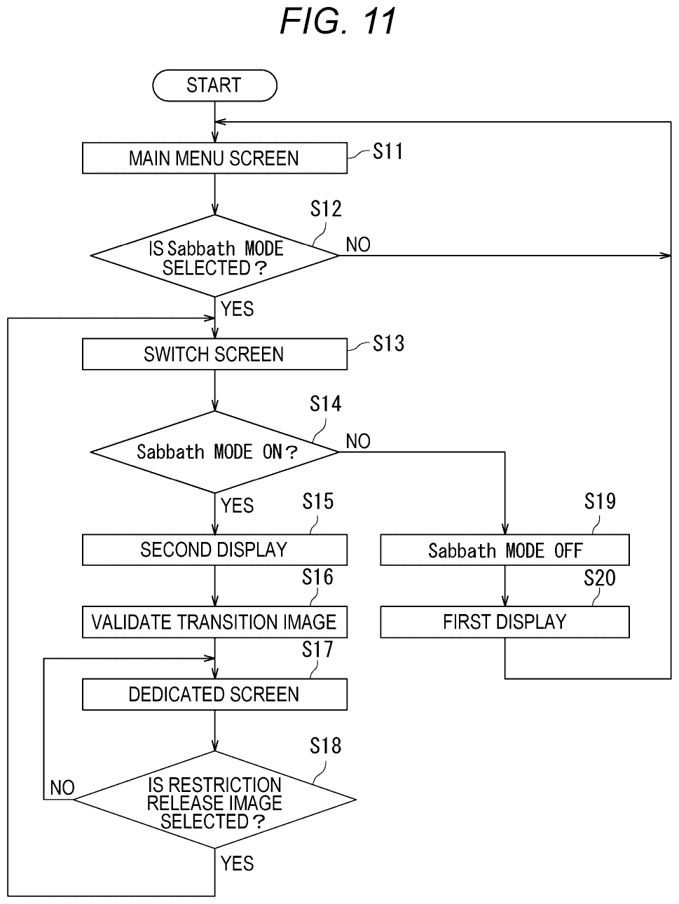

Next, a mode switching method in the cooking system 1 according to the present embodiment will be described with reference to FIG. 11. FIG. 11 is a flowchart illustrating a mode switching method in the cooking system 1 according to the present embodiment.

The control unit 13 controls the display unit 14 to display the main menu screen V1 (step S11).

The control unit 13 controls the display unit 14 to continue the display of the main menu screen V1 until the icon S2 indicating the restricted mode (Sabbath MODE) is selected on the main menu screen V1 (No in step S12). On the other hand, when the icon S2 is selected (Yes in step S12), the control unit 13 controls the display unit 14 to display the switch screen V2 (step S13).

On the switch screen V2, each time the switch icon S3 is selected, the selected state (ON) or the non-selected state (OFF) of the restricted mode (Sabbath MODE) is switched (step S14). In a case where the selected state (ON) of the restricted mode (Sabbath MODE) is selected (Yes in step S14), the control unit 13 switches the cooking system 1 to the restricted mode (Sabbath MODE), and controls the display unit 14 such that the switch icon S3 on the switch screen V2 is switched to be displayed in the second display (step S15).

In addition, the control unit 13 controls the display unit 14 to perform a normal display by cancelling the display of the icon S4 (transition image) in a grayed-out manner, and to validate the icon S4 (transition image) (step S16).

When the valid icon S4 is selected, the control unit 13 controls the display unit 14 to display a dedicated screen for the restricted mode (Sabbath MODE) (step S17).

The control unit 13 controls the display unit 14 to continue the display of the dedicated screen until the icon S91 or the icon S92 (restriction release image) included in the dedicated screen is selected (No in step S18). On the other hand, when the icon S91 or the icon S92 is selected (Yes in step S18), the control unit 13 controls the display unit 14 to display the switch screen V2 (step S13).

On the other hand, on the switch screen V2, in a case where the non-selected state (OFF) of the restricted mode (Sabbath MODE) is selected (No in step S14), the control unit 13 switches the cooking system 1 to the normal mode (step S19), and controls the display unit 14 such that the switch icon S3 on the switch screen V2 is switched to be displayed in the first display (step S20). The control unit 13 controls the display unit 14 to display the main menu screen V1 (step S11).

The embodiments of the present disclosure have been described above with reference to the drawings. However, the present disclosure is not limited to the embodiments described above, and can be implemented in various aspects without departing from the gist thereof. In addition, the plurality of constituent elements disclosed in the embodiments described above can be appropriately modified. For example, a certain constituent element of all the constituent elements in a certain embodiment may be added to a constituent element of another embodiment, or some constituent elements of all the constituent elements in a certain embodiment may be deleted from the embodiment.

In the present embodiment, the cooking system 1 includes the oven 10 and the microwave oven 20, but the cooking system 1 may include only one of the oven 10 and the microwave oven 20. In addition, the cooking system 1 may include an oven in which an oven and a microwave oven are integrated.

In the present embodiment, in a case where the power supply of the cooking system 1 is cut off in the restricted mode (Sabbath MODE), when the power supply of the cooking system 1 is turned on again, the control unit 13 activates the cooking system 1 in the restricted mode (Sabbath MODE). For example, in a case where the power supply of the cooking system 1 is cut off in a state where the temperature setting screen V3, the heating period setting screen V4, the preheating screen V5, or the heating screen V6 is displayed on the display unit 14, when the power supply of the cooking system 1 is turned on again, the control unit 13 controls the display unit 14 such that, among the temperature setting screen V3, the heating period setting screen V4, the preheating screen V5, and the heating screen V6, the screen that was displayed on the display unit 14 before the power supply was cut off is displayed.

In addition, the drawings schematically illustrate each constituent element mainly in order to facilitate understanding of the invention, and the thickness, length, number, interval, and the like of each illustrated constituent element may be different from the actual ones for convenience of drawing. In addition, the configuration of each constituent element illustrated in the embodiment described above is an example, and is not particularly limited, and it goes without saying that various modifications can be made without substantially departing from the effects of the present disclosure.

The present disclosure is applicable to the field of heating cookers.

What is claimed is:

1. A heating cooker comprising:
a first heating cooking chamber in which a cooking target is accommodated;
a heating unit configured to heat the cooking target;
a display unit configured to display a screen related to cooking of the cooking target;
an operation unit configured to receive an operation of a user; and
a control unit configured to control the heating unit and the display unit,
wherein the display unit displays a switch image indicating switching as to whether or not some functions of heating processing by the heating unit are restricted,
when an operation of switching to restrict the some functions is received by the operation unit, the control unit controls the heating unit such that the some functions are restricted, and
the some functions correspond to actions restricted on Jewish Sabbath.

2. The heating cooker according to claim 1, wherein
when the operation of switching to restrict the some functions is received by the operation unit, the display unit displays or validates a transition image transitioning to a screen for performing the heating processing by the heating unit with the some functions restricted, and
when an operation of transitioning to the screen for performing the heating processing by the heating unit with the some functions restricted is received by the operation unit, the display unit displays at least one of a heating period setting image indicating period setting of the heating by the heating unit and a heating temperature setting image indicating temperature setting of the heating by the heating unit.

3. The heating cooker according to claim 1, wherein the display unit displays a restriction release image guiding release of restriction of the some functions in a state where the cooking target is being subjected to the heating processing by the heating unit.

4. The heating cooker according to claim 1, wherein in a state where the some functions are restricted, the operation unit receives only an operation related to functions other than the some functions that are restricted.

5. The heating cooker according to claim 4, wherein the some functions include supply of microwaves.

6. The heating cooker according to claim 5, further comprising:
a second heating cooking chamber in which the cooking target is accommodated;
a drawer unit configured to be drawable with respect to the second heating cooking chamber; and
a lighting device configured to illuminate an inside of the second heating cooking chamber,
wherein in a case of switching to a state where the some functions are restricted, the control unit performs control such that the drawer unit is pushed in the second heating cooking chamber, and performs control such that the lighting device is turned off.
